(19) United States
(12) Patent Application Publication
(10) Pub. No.: US 2016/0281928 A1
(43) Pub. Date: Sep. 29, 2016

(54) HYDROGEN PRECOOLING SYSTEM

(71) Applicant: HITACHI PLANT MECHANICS CO., LTD., Kudamatsu-shi (JP)

(72) Inventors: Jun YOSHIDA, Kudamatsu-shi (JP); Takayuki KANEKO, Kudamatsu-shi (JP)

(73) Assignee: HITACHI PLANT MECHANICS CO., LTD., Kudamatsu-shi (JP)

(21) Appl. No.: 15/042,587

(22) Filed: Feb. 12, 2016

(30) Foreign Application Priority Data
Mar. 23, 2015 (JP) 2015-059323

(51) Int. Cl. F17C 5/06

(52) U.S. Cl. CPC F17C 5/06; F17C 2221/012; F17C 2223/0123; F17C 2225/0123; F17C 2270/0168; F17C 2270/0184; F17C 2227/0358; F17C 2227/0362

(57) ABSTRACT

[Purpose]

[Problem] To present a precooling system for lowering the temperature of hydrogen gas at a final filling unit of a hydrogen of a hydrogen station simple in construction, small in the load of maintenance and management tasks, and capable of lowering the running cost including the cost of consumption power source.

[Solving Means] To precool hydrogen gas by lowering the temperature of hydrogen gas by an expander 11 in a process of expanding and compressing the hydrogen gas, and by making use of its cold heat energy.

### TECHNICAL FIELD

The present invention relates to a hydrogen system, especially, to an attachment system of a hydrogen filling facility for filling a fuel tank of a hydrogen vehicle such as a fuel cell automobile (hereinafter called hydrogen vehicle) with a hydrogen gas as a fuel, from a hydrogen gas supply source, more particularly to a precooling system used for lowering the temperature of the hydrogen gas at a final filling unit of a hydrogen station.

### BACKGROUND ART

The hydrogen gas used as fuel for a hydrogen vehicle, when expanded adiabatically from high temperature (isenthalpic expansion) in a portion of expansion valve or the like provided in a path for filling with hydrogen gas, is expanded in a region of higher region than its reversing temperature (−58° C.) due to its properties, and is hence characterized to be elevated in temperature before expansion owing to the Joule-Thompson effect.

Therefore, at a hydrogen station, when filling a fuel tank of a hydrogen vehicle with hydrogen gas as the fuel for the hydrogen vehicle, from a hydrogen gas supply source, the temperature of the hydrogen gas elevates in a portion of expansion valve or the like provided in a path for filling with hydrogen gas.

This temperature rise of hydrogen gas is more evident when the expansion ratio of hydrogen gas is greater, and along with elevation of supply gas pressure from the hydrogen gas source at a hydrogen station (for example, from 45 to 70 MPa (G) or 82 MPa (G)), the own temperature elevation degree is much higher.

For example, when the hydrogen gas is expanded once from 70 MPa (G), 30° C., an example of own temperature change at each secondary pressure is shown in FIG. 1.

On the other hand, in the currently developed fuel cell vehicle, the maximum temperature limit in hydrogen filling is about 85° C., due to temperature limits by material of the fuel tank, and operating temperature limits of the fuel cell main body.

Moreover, owing to the properties of the hydrogen, when filled with hydrogen gas directly without installing any means, the temperature at the time of filling with hydrogen exceeds maximum temperature upper limit of 85° C., which leads to various problems such as temperature limits due to material of the fuel tank, operation temperature limits of the fuel main body cell, and lowering of pressure due to cooling after filling, and hence various methods have been proposed and realized, such as heat exchanger or other cooling means disposed in a route for filling with hydrogen gas, and filling a hydrogen vehicle with hydrogen gas while cooling by this cooling means (see, for example, Patent Document 1).

### PRIOR PATENT DOCUMENT

### Patent Document

[Patent Document 1] Japanese Patent Laid-open Publication No. 2004-116619

### OUTLINE OF THE INVENTION

### Problems to be Solved by the Invention

Herein, FIG. 2 shows a configuration of a current general hydrogen station of 70 MPa (G).

This hydrogen station includes a compressor facility 1 having a compressor unit for receiving hydrogen gas, a hydrogen reserve pressure facility 2 having a pressure reservoir unit for reserving and pressing hydrogen sent from the compressor facility 1, an expansion valve 3 and a hydrogen gas precooler 4 disposed in a path for filling s fuel tank 6 of a hydrogen vehicle with the hydrogen gas from the hydrogen reserve pressure facility 2, and a precooling system 5 for cooling the hydrogen gas by way of the precooler 4, and further the precooling system 5 comprises a refrigerating machine facility 7 having a compressor, a condenser, an expansion valve, an evaporator, and an accumulator and others, and a brine circuit 8 having a brine tank, a primary brine pump, a secondary pump, and others.

In the hydrogen station, that is, the hydrogen station whether of on-site type or of off-site type, the received hydrogen is once compressed in the compressor facility 1 to an intermediate pressure (40 MPa (G) in the illustrated example or 82 MPa (G) in the illustrated example), and is maintained in a form of compressed gas in the in the reserve pressure unit of the hydrogen reserve pressure facility 2.

When the hydrogen gas is charged into the car-mount fuel tank 6 at the demand side, it is expanded by way of the expansion valve 3, but at this time since the process is accompanied by pressure rise of hydrogen gas, it is cooled to −40° C. by the precooling system 5 included in the external facility.

In the existing technology, this precooling system 5 is a combined system of an ordinary refrigerating machine facility 7 of Freon refrigerant or the like, and a brine circuit 8 operating near −40° C., and hence the construction is complicated, and many rotating machines are needed such as refrigerating compressor for refrigerating machine, primary brine pump, secondary brine pump, and others.

Accordingly there were many problems in the precooling system used in the final filling step of conventional hydrogen system for lowering the temperature of the hydrogen gas, among them:

1) The externally independent precooling system is a system that is operated by an external electric power. In a general hydrogen station (300 Nm³/h), it is about 40 kW, and the operation of the precooling system itself causes to elevate the running cost.

2) It is legally controlled because Freon (substitute Freon) is used as the refrigerant of the refrigerating machine, and this precooler facility itself is regulated by the refrigeration safety regulation of the high pressure gas safety law, and the facility and its operation are restricted.

3) Where Freon or brine is contained in a station, preventive measures against environmental accidents of external leaks of Freon or brine are needed.

4) The precooling system is complicated in structure consisting of two circuits of refrigerating circuit and brine circuit, and the system comprises a plurality of rotating machines such as refrigerant compressor and brine pump, and many maintenance and management tasks are involved.

5) Because of the system using brine, it takes time from start of operation until a stationary state is established. Hence, considerably before the filling work, it is required to start the precooling system in advance to keep the system in stationary state.

6) When downsizing the installation space of the hydrogen station, the occupation space of the precooling system is its limit.

7) At the present temperature of −40° C., further restrictions arise in rapid filling of hydrogen. In future, to shorten the filling time further, it is required to precool lower than the present temperature of −40° C.

The present invention relates to problems of the precooling system used for lowering the temperature of hydrogen gas at the final filling point of the conventional hydrogen station, and it is hence a primary object thereof to present a precooling system used for lowering the temperature of hydrogen gas at the final filling point of the hydrogen station, simple in construction, low in the burden of the maintenance and management tasks, and capable of lowering the running cost including the cost of power consumption.

### Means for Solving the Problems

In order to achieve the object, the hydrogen precooling system of the present invention is a hydrogen precooling system in a hydrogen filling facility for filling a tank with hydrogen gas reserved at high pressure by pressure differential expansion by way of an opposite side valve, in which the hydrogen gas is precooled by lowering the temperature of hydrogen gas by an expansion machine in a process of expanding and decompressing, and by making use of its cold heat energy.

In this case, the expansion machine is realized by utilizing or combining any one of hydrogen turbine, reciprocating mechanical expander, rotary expander, and scroll type expander.

### Effects of the Invention

According to the hydrogen precooling system of the invention, in a hydrogen precooling system in a hydrogen filling facility for filling a tank with hydrogen gas reserved at high pressure by pressure differential expansion by way of an opposite side valve, in a process of expanding and compressing, by expanders, more specifically, for example, by hydrogen turbine, reciprocating mechanical expander, rotary expander, and scroll type expander, or a combination of them, the hydrogen gas is lowered in temperature, and the hydrogen gas is precooled by making use of this cold heat energy, it is possible to present a precooling system used for lowering the temperature of the hydrogen gas at the final filling spot of the hydrogen system, simple in construction, small in burden of maintenance and management tasks, lowered in running cost including the power consumption cost, and lowered in the temperature of hydrogen gas.

### BRIEF DESCRIPTION OF THE DRAWINGS

FIG. 1 is a graph showing an example of temperature rise due to expansion using an expansion valve of hydrogen gas (valve expansion) and expansion using hydrogen turbine (turbine expansion).

FIG. 2 is an explanatory diagram of a hydrogen station using a conventional hydrogen precooling system.

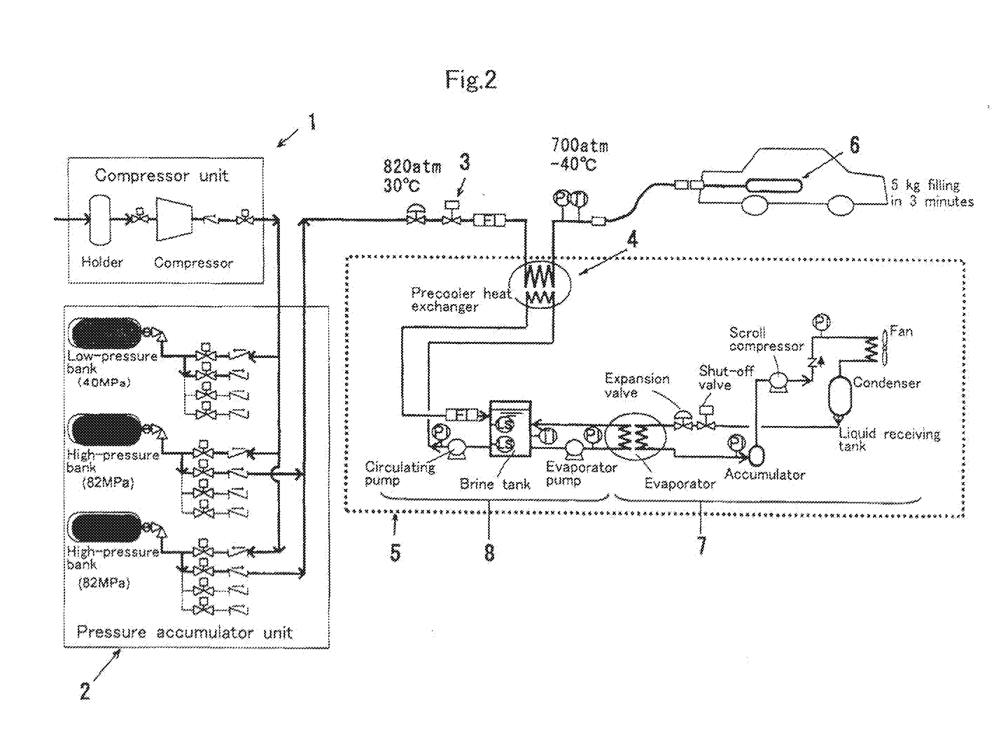

FIG. 3 is an explanatory diagram of an embodiment of the hydrogen precooling system of the present invention.

FIG. 4 is an explanatory diagram of a modified embodiment of the hydrogen precooling system of the present invention.

### BEST MODE FOR CARRYING OUT THE INVENTION

An embodiment of the hydrogen precooling system of the present invention is described below by reference to the accompanying drawings.

This hydrogen precooling system is a precooling system used for lowering the temperature of hydrogen gas at a final filling unit of the hydrogen station, that is, in a hydrogen precooling system installed in a hydrogen filling facility for filling a tank with hydrogen gas reserved at a high pressure by pressure differential expansion by way of an opposite side valve, the temperature of the hydrogen gas is lowered by an expander in a process of expanding and compressing the hydrogen gas, and the hydrogen gas is precooled by lowering the temperature of hydrogen gas by an expansion machine in a process of expanding and decompressing, and the hydrogen gas is precooled by making use of its cold heat energy.

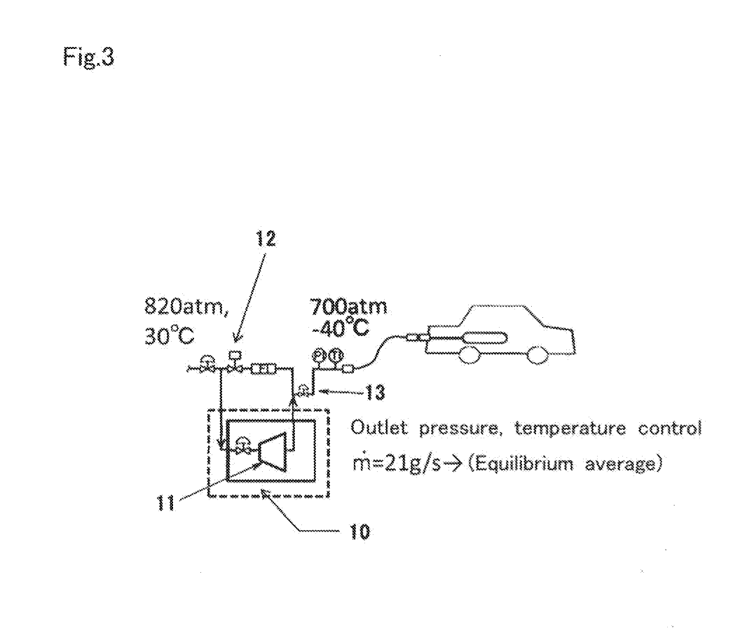

More specifically, as in a final expansion mechanism of hydrogen gas of a hydrogen station shown in FIG. 3, a partial gas of hydrogen gas supply line is branched, and a circuit of an expansion turbine is provided.

In the expansion turbine, the hydrogen is expanded, and the hydrogen gas is lowered in temperature and mixed in again. As required, alternatively, the gas is expanded to an intermediate pressure and mixed, and the tank is finally expanded and filling at a final small expansion ratio.

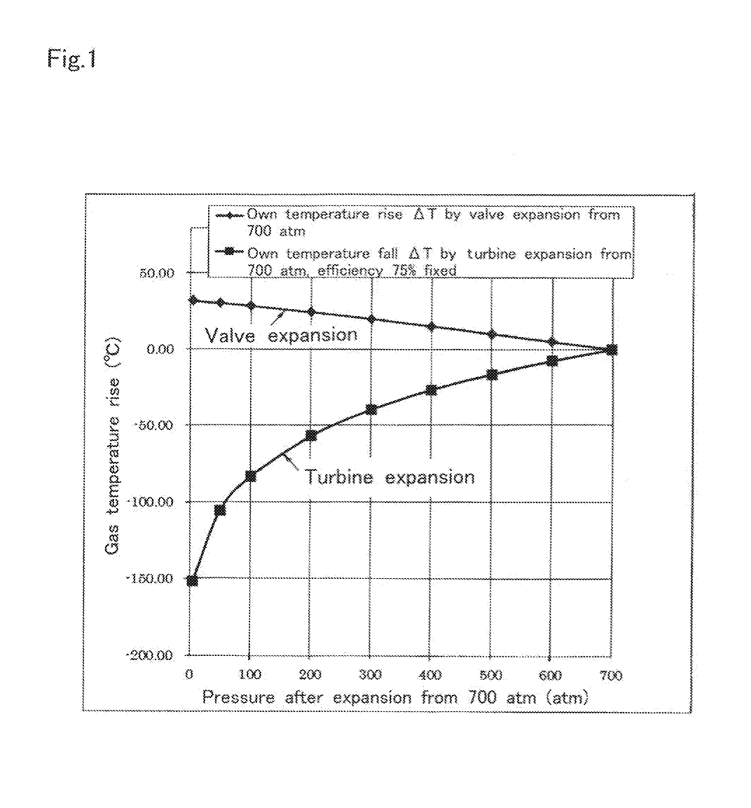

In FIG. 3, the high pressure hydrogen gas branched in a state of high pressure is supplied into the hydrogen tank by way of a turbine inlet valve, and the expansion due to hydrogen turbine always causes temperature decline (see FIG. 1, herein, FIG. 1 is an example of calculation, and the outlet temperature can be controlled in a wide range by setting of the expansion turbine inlet condition and expansion ratio and others), and hence the turbine outlet temperature is lowered from the inlet.

The gas after expansion is mixed with the gas normally expanded, and is controlled at an optimum temperature, and charge continuously into the tank finally at a low expansion ratio.

Consequently, the pressure at the filling opposite side and the temperature status are sensed by sensors, and feedback control is applied to obtain an optimum mixing temperature. By this temperature command, the steam turbine inlet temperature is controlled, and the flow rate of the turbine circuit is changed, and thereby the temperature lowering width and the appropriate temperature after mixing are maintained.

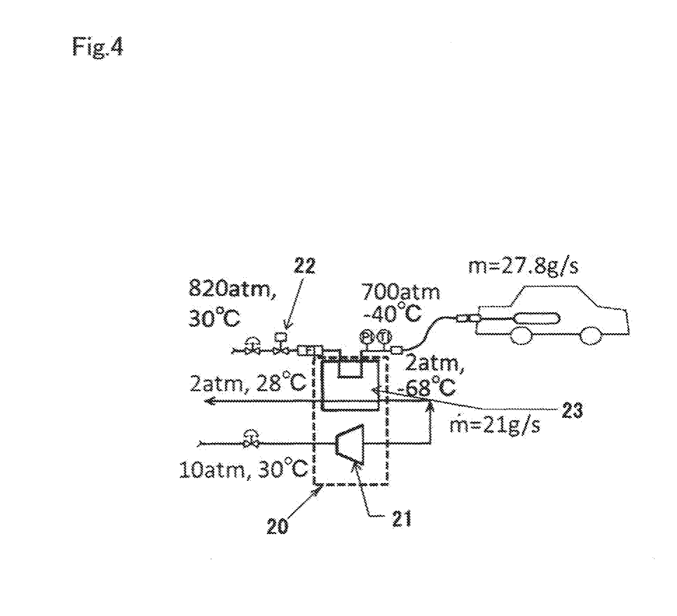

Further, as shown in FIG. 4, a temperature lowering circuit by an expansion turbine by extracting hydrogen gas from a pressure reservoir facility may be provided.

In this case, the expander may include conventional expanders, such as the hydrogen turbines 11, 21 (see, for example, Japanese Patent Laid-Open Publication No. 2003-106108, 2012-206909), reciprocating mechanical expander (see, for example, Japanese Patent Laid-Open Publication No. Sho61-262558), rotary type expander (see, for example, Japanese Patent Laid-Open Publication No. 2007-9755), and scroll type expander (see, for example, International Patent Laid-Open Publication No. WO2012/164609), either alone or in combination thereof.

The means for taking out energy by the expander may include the following methods.

1) Control by brake fan (converting to heat by water-cooled cooler)

2) Power generation control by incorporating a power generator

3) Process hydrogen pressure elevation by boosting blower

This hydrogen precooling system conforms to the principle explained above, and solves the problems of the precooling system used for lowering the temperature of the hydrogen gas in the final filling unit of a conventional hydrogen station as follows.

Problem 1) External electric power is not needed for operation of expanders such as hydrogen expansion turbine, and almost no electric power is needed in running cost (electric fee) of the conventional precooling system.

Problem 2) Refrigerant is not used, and independently the system is free of load on the refrigeration side. The hydrogen station itself can be handled within the high-pressure gas safety regulation.

Problem 3) Freon refrigerant or brine is not used, and there is no risk about environmental accident.

Problem 4) The system configuration is simple, and not only the running cost but also the maintenance cost are substantially saved.

Problem 5) Temperature is lowered simultaneously upon start of expander such as expansion turbine, and the time constant in the system is small. Prior start time is very short.

Problem 6) Only the cold box of expander such as expansion turbine is needed, and hence the space is saved substantially.

Problem 7) By the expander such as expansion turbine, the temperature can be cooled nearly to −100° C., and it is possible to apply to faster filling.

Herein, the hydrogen precooling system of the present invention is explained by reference to its embodiment, but the invention is not limited to the construction described in the embodiment, but the construction may be modified or changed appropriately within the scope not departing from the illustrated example.

### INDUSTRIAL APPLICABILITY

The hydrogen precooling system of the invention is simple in construction, small in the load of the maintenance and management facilities, and is low in the running cost including the cost of power consumption, and is hence preferably applicable to installation of precooling system used for lowering the temperature of hydrogen gas in the final filling unit of a hydrogen station.

### DESCRIPTION OF REFERENCE NUMERALS

1 Compressor facility
2 Hydrogen reserve pressure facility
3 Expansion valve
4 Precooler
5 Precooling system
6 Fuel tank
7 Refrigerating machine facility
8 Brine circuit
10 Precooling system
11 Hydrogen turbine (expander)
12 First expansion valve
13 Second expansion valve
20 Precooling system
21 Hydrogen turbine (expander)
22 First expansion valve
23 Precooler

1. A hydrogen precooling system for precooling the hydrogen gas for precooling the hydrogen gas by lowering the temperature of hydrogen gas by an expander in the process of expanding and decompressing the hydrogen gas, and by making use of its cold heat energy, in a hydrogen precooling system of a hydrogen filling facility for filling the tank with hydrogen gas compressed at high pressure by a pressure differential expansion by way of an opposite side valve.

2. The hydrogen precooling system as set forth in claim 1, wherein the expander is composed by any one or others of hydrogen turbine, reciprocating mechanical expander, rotary type expander, and scroll type expander.
